(19) United States
(12) Patent Application Publication
(10) Pub. No.: US 2020/0184505 A1
(43) Pub. Date: Jun. 11, 2020

(54) Smart Operation System for Puzzle Collection

(71) Applicant: SHENG-CHUN LIN, Hsinchu County (TW)

(72) Inventor: SHENG-CHUN LIN, Hsinchu County (TW)

(21) Appl. No.: 16/355,808

(22) Filed: Mar. 17, 2019

(30) Foreign Application Priority Data
Dec. 11, 2018 (TW) 107144564

(51) Int. Cl. G06Q 30/02

(52) U.S. Cl. CPC G06Q 30/0233; G06Q 30/0238; G06Q 30/0231

(57) ABSTRACT

A smart operation system for puzzle collection comprises a servo device, a puzzle collection data cloud, a consumer operating device, a merchant operating device and a display device. The puzzle collection data cloud is communicatively connected to the servo device. The consumer operating device is communicatively connected to the servo device and the puzzle collection data cloud, separately. The merchant operating device is communicatively connected to the servo device, the puzzle collection data cloud and the consumer operating device, separately. The display device is communicatively connected to the servo device, the puzzle collection data cloud, the consumer operating device and the merchant operating device, separately.

### BACKGROUND OF THE INVENTION

### 1. Field of the Invention

The present invention relates to a smart operation system, and more particularly to a smart operation system for puzzle collection.

### 2. Description of the Related Art

In order to attract consumers to a specific merchant for consumption, each merchant will launch a collection card, and corresponding commodities (or services) can be exchanged when the consumer collects a certain number of points, that is, after the consumer completes a certain amount of consumption. However, such a collection method is too monotonous to further stimulate consumers' consuming behaviors.

### SUMMARY OF THE INVENTION

With this respect, an object of the present invention is to provide a smart operation system for puzzle collection, for authorizing each merchant to provide puzzle elements for consumers to collect, and the puzzle elements held by the consumers can be exchanged with each other, and the corresponding commodities (or points, or gift vouchers) can be exchanged after the entire puzzles are collected. In this way, the motivation and enjoyment of the consumers to participate in the puzzle collection activity is increased, and thus, the willingness of the consumer to consume is increased, and the sales of the commodities (or services) of each merchant are facilitated.

The smart operation system for puzzle collection of the present invention is a smart operation system for puzzle collection capable of operating and managing, through a smart internet, a specific image that is rewarded for the consumption of a consumer for purchasing a commodity (or service) from a merchant and is exchangeable to obtain a prize. An embodiment of the smart operation system of the present invention comprises a servo device, a puzzle collection data cloud, a consumer operating device, a merchant operating device and a display device. The puzzle collection data cloud is communicatively connected to the servo device and comprises at least one puzzle collection database for accessing, and at least one encryption security module having an encryption security function for the puzzle collection database. The consumer operating device is communicatively connected to the servo device and the puzzle collection data cloud separately and is a first smart electronic device having the function of enabling the consumer to obtain and access to exchange information between the puzzle collection information and the consumer from the merchant or the puzzle collection data cloud by purchasing a special commodity (or service). The merchant operating device is communicatively connected to the servo device, the puzzle collection data cloud and the consumer operating device separately, and the merchant operating device is a second smart electronic device at least having the function of deciding whether the consumer can obtain puzzle collection related information from the merchant or the puzzle collection data cloud when the consumer purchases the special commodity (or service) and the function of exchanging information between the consumers. The display device is communicatively connected to the servo device, the puzzle collection data cloud, the consumer operating device and the merchant operating device separately, and the display device is a third smart electronic device having the function of displaying at least merchant information, commodity (or service) information, consumer information, puzzle collection exchange and redemption information, and prize reception information.

The above and other objects, features, and advantages of the present invention will become apparent in the following detailed description of the embodiments with reference to the accompanying drawings.

### BRIEF DESCRIPTION OF THE DRAWINGS

FIG. 1 is a system block diagram of an embodiment of a smart operation system for puzzle collection according to the present invention.

FIG. 2 is a system block diagram of another embodiment of a smart operation system for puzzle collection according to the present invention.

FIG. 3 is a system block diagram of another embodiment of a smart operation system for puzzle collection according to the present invention.

FIG. 4 is a system block diagram of another embodiment of a smart operation system for puzzle collection according to the present invention.

### DETAILED DESCRIPTION OF THE PREFERRED EMBODIMENTS

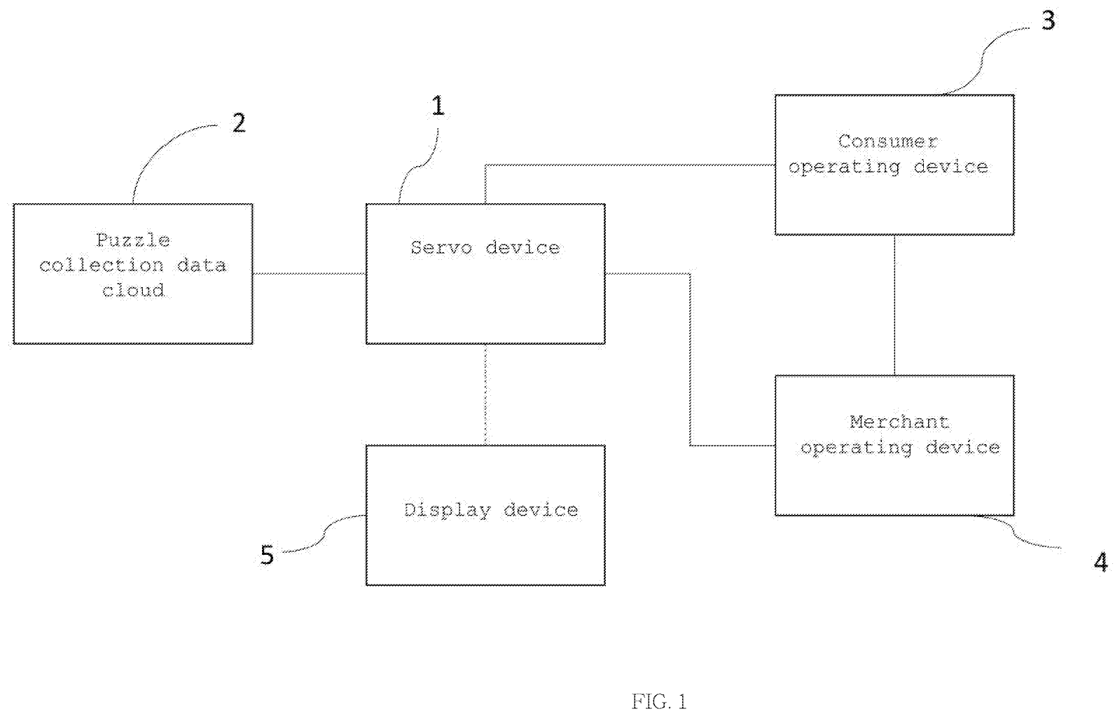

Referring to FIG. 1, it illustrates an embodiment of a smart operation system for puzzle collection according to the present invention. The smart operation system for puzzle collection of the present invention comprises a servo device 1, a puzzle collection data cloud 2, a customer operating device 3, a merchant operating device 4 and a display device 5.

The puzzle collection data cloud 2 is communicatively connected to the servo device 1. The puzzle collection data cloud 2 stores a plurality of puzzle collections, and the puzzle collection is at least one of a specific string formed by arranging a plurality of characters, a specific graph formed by arranging a plurality of patterns, and a combination thereof.

The consumer operating device 3 is communicatively connected to the servo device 1, and is communicatively connected to the puzzle collection data cloud 2 through the servo device 1. In this embodiment, the consumer operating device 3 is a second smart electronic device having the function of enabling the consumer to obtain and access to exchange information between the puzzle collection information and the consumer from the merchant or the puzzle collection data cloud by purchasing a special commodity (or service).

The merchant operating device 4 is communicatively connected to the servo device 1 and the consumer operating device 3 separately, and the merchant operating device 4 is communicatively connected to the puzzle collection data cloud 2 through the servo device 1. The merchant operating device 4 may be a second smart electronic device at least having the function of deciding whether the consumer can obtain puzzle collection related information from the merchant or the puzzle collection data cloud when the consumer purchases the special commodity (or service) and the function of exchanging information between the consumers.

The display device 5 is communicatively connected to the servo device 1, and is communicatively connected to the puzzle collection data cloud 2, the consumer operating device 3 and the merchant operating device 4 through the servo device 1, separately. The display device 5 may be a third smart electronic device having the function of displaying at least merchant information, commodity (or service) information, consumer information, puzzle collection exchange and redemption information, and prize reception information.

The first smart electronic device, the second smart electronic device and the third smart electronic device can be all or partially identical, comprising at least one of a mobile phone, a notebook computer, a tablet computer, a cloud server, a Point of Sale (POS) machine, a desktop computer, a smart wearable device, smart household appliances, a robot, an Artificial Intelligence (AI) device, a Personal Digital Assistant (PDA) device, an electronic signage, and a combinations thereof.

The first smart electronic device, the second smart electronic device and the third smart electronic device can be all or partially identical, comprising at least one of a mobile phone, a tablet phone, a notebook computer, a tablet computer, a cloud server, a POS machine, a desktop computer, a smart wearable device, smart household appliances, a robot, an AI device, an electronic signage, and a combinations thereof.

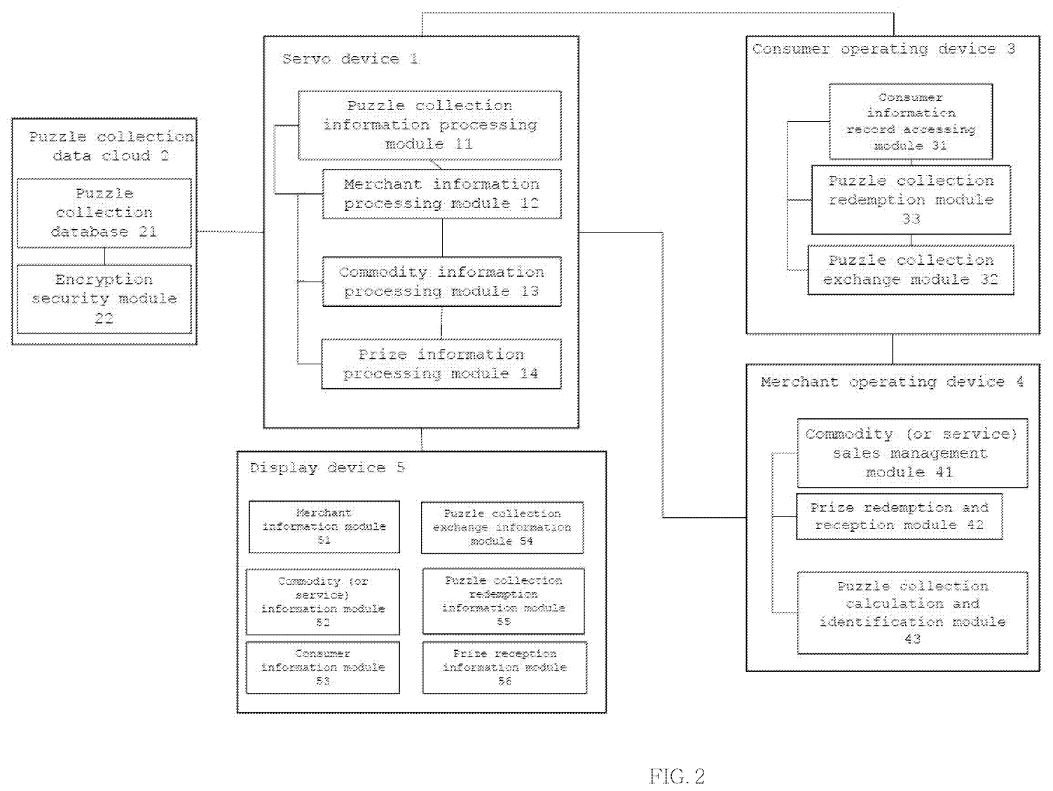

Referring to FIG. 2, it illustrates another embodiment of a smart operation system for puzzle collection according to the present invention. In this embodiment, the connection relationships of the servo device 1, the puzzle collection data cloud 2, the consumer operating device 3, the merchant operating device 4 and the display device 5 are the same as those of the embodiment of FIG. 1.

In this embodiment, the servo device 1 comprises a puzzle collection information processing module 11, a merchant information processing module 12, a commodity (or service) information processing module 13 and a prize information processing module 14. The puzzle collection information processing module 11 is configured to store, compute, receive and provide a plurality of different puzzle collection information, and each of the puzzle collection information respectively comprises at least one verification data for anti-counterfeiting. The merchant information processing module 12 is configured to store, compute, receive and provide at least one merchant information map for the consumer to view and search fora sales store, and the merchant information map comprises at least one special merchant information about the location of a special merchant, and/or at least one general merchant information about the location of a general merchant, and at least one prize redemption merchant information about the location of a prize redemption merchant. The merchant information processing module 12 may further provide at least one merchant distance information about a decision for the consumer to search for the sales store and select to visit the merchant. The commodity (or service) information processing module 13 is configured to store, compute, receive and provide at least one commodity (or service) information map for the consumer to view and search for a commercially available commodity (or service), and the commodity (or service) information map comprises at least one special commodity (or service) information about a type and a price of at least one of a special commodity (or service), puzzle collection redemption information, and a sales location thereof. The prize information processing module 14 is configured to store, compute, receive and provide at least one prize redemption information about prize redemption, reception, and other related operations.

In this embodiment, the servo device 1 further comprises a location computing module 15 configured to calculate the distance and positioning between the consumer and the merchant by using at least one of wired transmission, wireless communication, Bluetooth technology, Global Positioning System (GPS), Near Field Communication (NFC), or a combination thereof.

In this embodiment, the puzzle collection data cloud 2 comprises a puzzle collection database 21 and an encryption security module 22. The encryption security module 22 is connected to the puzzle collection database 21. The puzzle collection database 21 stores the plurality of puzzle collections. Puzzle collection elements are encrypted by the encryption security module 22 when the servo device 1 reads the puzzle collection elements in the puzzle collection database 21.

In this embodiment, the consumer operating device 3 comprises at least one consumer information record accessing module 31, at least one puzzle collection redemption module 32 and at least one puzzle collection exchange module 33. The consumer information record accessing module 31 can upload, download, record and access exchange of puzzle collection between the consumers and related information thereof. The puzzle collection redemption module 32 can upload, download, record and access whether the puzzle collection of the consumer completes the specific pattern, whether to redeem the prize, whether to receive the prize and related information thereof. The puzzle collection exchange module 33 is configured to exchange puzzle elements with another consumer operating device 3.

In this embodiment, the merchant operating device 4 comprises at least one commodity (or service) sales management module 41, at least one prize redemption and reception module 42, and at least one puzzle collection calculation and identification module 43. The commodity (or service) sales management module 41 can upload, download, record and access names, types, quantities and related information of commodities (or services) sold by the merchant. The prize redemption and reception module 42 can upload, download, record and access the consumer's puzzle collection related information, whether to complete a specific puzzle, whether to redeem and receive the prize and related information thereof. The puzzle collection calculation and identification module 43 can enable the merchant or the puzzle collection data cloud to check and identify, and upload, download, record and access whether the consumer completes the specific puzzle or whether the consumer can redeem and receive the prize.

In this embodiment, the display device 5 comprises at least one merchant information module 51, at least one commodity (or service) information module 52, at least one consumer information module 53, at least one puzzle collection exchange information module 54, at least one puzzle collection redemption information module 55 and a prize reception information module 56. The merchant information module 51 can upload, download, record and access the merchant's geographic location, the sold commodities (or services), the redemptive prizes and related information thereof. In another embodiment, the merchant information module 51 can provide information of capturing specific puzzle elements at a certain merchant or a specific location. The commodity (or service) information module 52 can upload, download, record and access the commodities (or services) purchased by the consumer, the commodities (or services) sold by the merchant and related information thereof. The consumer information module 53 can upload, download, record and access the merchants visited by the consumer, the visit frequency, the purchased commodities (or services) and related information. The puzzle collection exchange information module 54 can upload, download, record and access a puzzle collection and related information that the consumer desires to acquire, exchange or transfer. The puzzle collection redemption information module 55 can upload, download, record and access the type, frequency, geographical location and related information of the prize redeemed by the consumer with the puzzle collection. The prize reception information module 56 can upload, download, record and access the prizes received by the consumer, types and the reception time and, the merchants and related information.

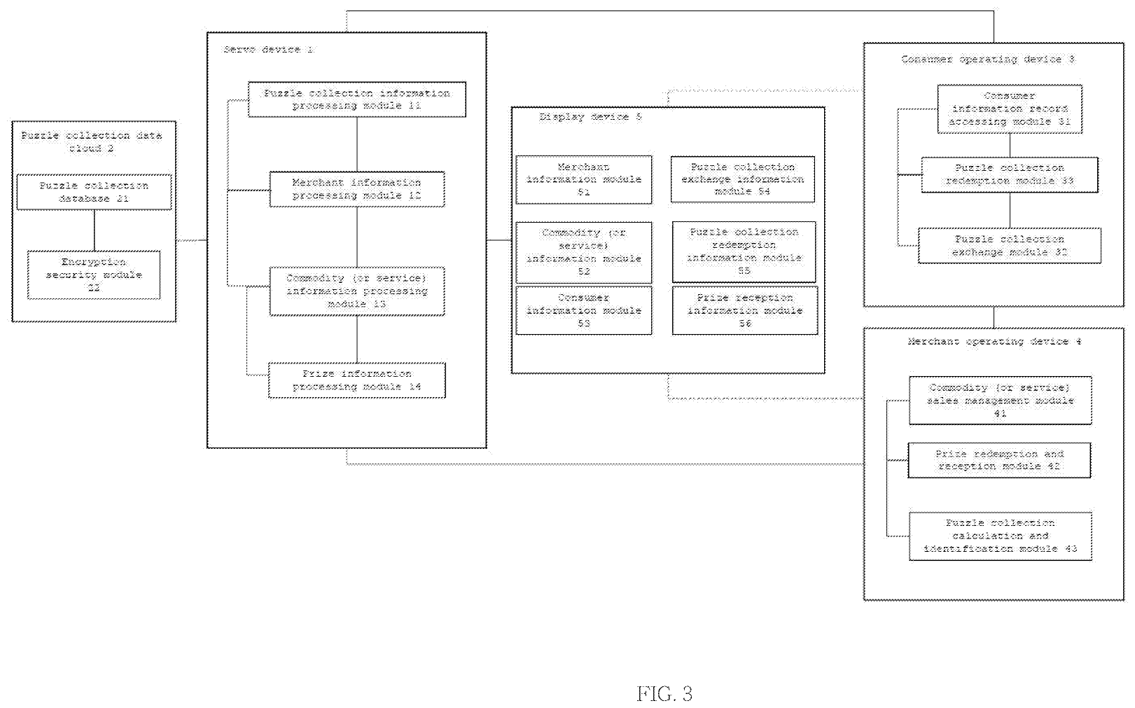

Referring to FIG. 3, it illustrates another embodiment of a smart operation system for puzzle collection according to the present invention. The smart operation system for puzzle collection of this embodiment has a similar structure as that of the embodiment of FIG. 2, and therefore, the same elements are represented by the same symbols and the description is omitted. The difference between this embodiment and the embodiment of FIG. 2 is that the display device 5 is also directly communicatively connected to the consumer operating device 3 and the merchant operating device 4 apart from being communicatively connected to the servo device 1.

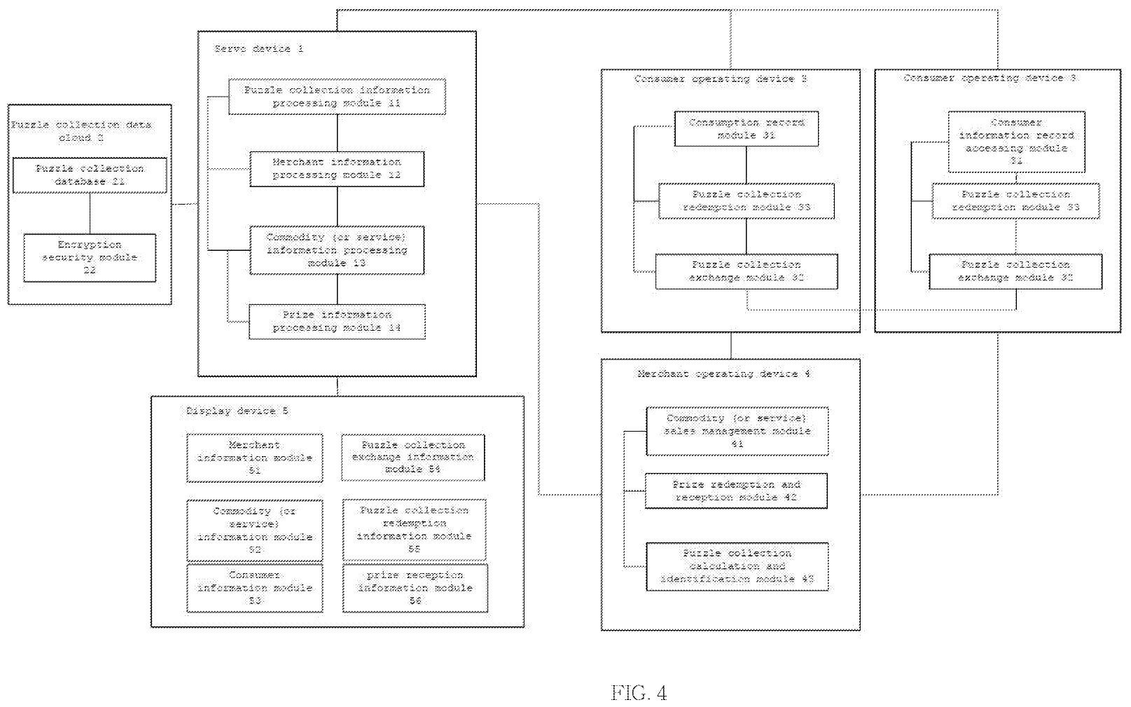

Referring to FIG. 4, it illustrates another embodiment of a smart operation system for puzzle collection according to the present invention. The smart operation system for puzzle collection of this embodiment has a similar structure as that of the embodiment of FIG. 2, and there fore, the same elements are represented by the same symbols and the description is omitted. The differences between this embodiment and the embodiment of FIG. 2 are that two consumer operating devices 3 are communicatively connected to the servo device 1 and the merchant operating device 4, and the puzzle collection exchange modules 32 of the two consumer operating devices 3 are communicatively connected to each other for exchange of puzzle collections.

The smart operation system for puzzle collection of the present invention provides puzzle elements to the merchants and the consumers, so that the consumers collect the puzzle elements with the goal of completing a puzzle, and the consumers can also exchange the collected puzzle elements with each other, to redeem for corresponding prizes after all the puzzle elements are collected, thereby encouraging the consumers to spend more and increasing the sales performance.

The present invention has been disclosed in the above embodiments, but it is not intended to limit the scope of the present invention. Persons of ordinary skill in the art can make a few changes and modifications, without departing from the spirit of the present invention. Therefore, the scope of protection of the present invention is subject to

[symbol]

What is claimed is:

1. A smart operation system for puzzle collection, which is a smart operation system for puzzle collection capable of operating and managing, through a smart internet, a specific image that is rewarded for the consumption of a consumer for purchasing a commodity (or service) from a merchant and is exchangeable to obtain a prize, and the smart operation system at least comprises:
a servo device comprising:
a puzzle collection information processing module, configured to store, compute, receive and provide a plurality of different puzzle collection information, each of the puzzle collection information respectively comprising at least one verification data for anti-counterfeiting;
a merchant information processing module, configured to store, compute, receive and provide at least one merchant information map for the consumer to view and search for a sales store, the merchant information map comprising at least one special merchant information about the location of a special merchant, and/or at least one general merchant information about the location of a general merchant, and at least one prize redemption merchant information about the location of a prize redemption merchant;
a commodity (or service) information processing module, configured to store, compute, receive and provide at least one commodity (or service) information map for the consumer to view and search for a commercially available commodity (or service), the commodity (or service) information map comprising at least one special commodity (or service) information about a type and a price of at least one of a special commodity (or service), puzzle collection redemption information, and a sales location thereof; and
a prize information processing module, configured to store, compute, receive and provide at least one prize redemption information about prize redemption, reception, and other related operations;
a puzzle collection data cloud, communicatively connected to the servo device and comprising at least one puzzle collection database for accessing, and at least one encryption security module having an encryption security function for the puzzle collection database;
a consumer operating device, communicatively connected to the servo device and the puzzle collection data cloud separately and being a second smart electronic device having the function of enabling the consumer to obtain and access to exchange information between the puzzle collection information and the consumer from the merchant or the puzzle collection data cloud by purchasing a special commodity (or service);
a merchant operating device, communicatively connected to the servo device, the puzzle collection data cloud and the consumer operating device separately, the merchant operating device being a first smart electronic device at least having the function of deciding whether the consumer can obtain puzzle collection related information from the merchant or the puzzle collection data cloud when the consumer purchases the special commodity (or service) and the function of exchanging information between the consumers; and
a display device, communicatively connected to the servo device, the puzzle collection data cloud, the consumer operating device and the merchant operating device separately, the display device being a third smart electronic device having the function of displaying at least merchant information, commodity (or service) information, consumer information, puzzle collection exchange and redemption information, and prize reception information.

2. The smart operation system for puzzle collection according to claim 1, wherein the puzzle collection is at least one of a specific string formed by arranging a plurality of characters, a specific graph formed by arranging a plurality of patterns, and a combination thereof.

3. The smart operation system for puzzle collection according to claim 1, wherein the merchant operating device or the first smart electronic device comprises at least one commodity (or service) sales management module capable of uploading, downloading, recording and accessing names, types, quantities and related information of commodities (or services) sold by the merchant; and/or
at least one prize redemption and reception module capable of uploading, downloading, recording and accessing the consumer's puzzle collection related information, whether to complete a specific puzzle, whether to redeem and receive the prize and related information thereof; and/or at least one puzzle collection check identification module capable of enabling the merchant or the puzzle collection data cloud to check and identify, and uploading, downloading, recording and accessing whether the consumer completes the specific puzzle or whether the consumer can redeem and receive the prize.

4. The smart operation system for puzzle collection according to claim 1, wherein the consumer operating device or the second smart electronic device comprises at least one consumer information access module capable of uploading, downloading, recording and accessing exchange of puzzle collection between the consumers and related information thereof; and/or
at least one puzzle collection redemption module capable of uploading, downloading, recording and accessing whether the puzzle collection of the consumer completes the specific pattern, whether to redeem the prize, whether to receive the prize and related information thereof.

5. The smart operation system for puzzle collection according to claim 1, wherein the display device or the third smart electronic device comprises at least one commodity (or service) information module capable of uploading, downloading, recording and accessing the commodities (or services) purchased by the consumer, the commodities (or services) sold by the merchant and related information thereof; and/or
at least one puzzle collection exchange information module capable of uploading downloading, recording and accessing a puzzle collection and related information that the consumer desires to acquire, exchange or transfer; and/or
at least one puzzle collection redemption information module capable of uploading, downloading, recording and accessing the type, frequency, geographical location and related information of the prize redeemed by the consumer with the puzzle collection.

6. The smart operation system for puzzle collection according to claim 5, wherein the display device or the third smart electronic device at least comprises at least one merchant information module capable of uploading, downloading, recording and accessing the merchant's geographic location, the sold commodities (or services), the redemptive prizes and related information thereof; and/or at least one consumer information module capable of uploading, downloading, recording and accessing the merchants visited by the consumer, the visit frequency, the purchased commodities (or services) and related information; and/or at least one prize reception information module capable of uploading, downloading, recording and accessing the prizes received by the consumer, types and the reception time, the merchants and related information.

7. The smart operation system for puzzle collection according to claim 6, wherein the merchant information module can provide information of capturing specific puzzle elements at a certain merchant or a specific location.

8. The smart operation system for puzzle collection according to claim 1, wherein the first smart electronic device, the second smart electronic device and the third smart electronic device can be all or partially identical, comprising at least one of a mobile phone, a notebook computer, a tablet computer, a cloud server, a POS machine, a desktop computer, a smart wearable device, smart household appliances, a robot, an AI, a PDA, an electronic signage, and a combinations thereof.

9. The smart operation system for puzzle collection according to claim 1, wherein the merchant information processing module further provides at least one merchant distance information about a decision for the consumer to search for the sales store and select to visit the merchant.

10. The smart operation system for puzzle collection according to claim 1, wherein the servo device further comprises a location computing module configured to calculate the distance and positioning between the consumer and the merchant by using at least one of wired transmission, wireless communication, Bluetooth technology, Global Positioning System (GPS), Near Field Communication (NFC), or a combination thereof.
